(19) United States
(12) Patent Application Publication
(10) Pub. No.: US 2010/0282520 A1
(43) Pub. Date: Nov. 11, 2010

(54) System and Methods for Monitoring Multiple Storage Units

(76) Inventors: Bruce C. Lucas, Marlow, OK (US); Steve Crain, Duncan, OK (US); Rebecca McConnell, Lone Grove, OK (US)

Correspondence Address: JOHN W. WUSTENBERG, P.O. BOX 1431, DUNCAN, OK, 73536, US

(21) Appl. No.: 12/435,551

(22) Filed: May 5, 2009

(51) Int. Cl. G01G 9/00

(52) U.S. Cl. 177/1

(57) ABSTRACT

System and methods for determining the amount of materials contained in individual storage units in a storage device with multiple storage units are disclosed. A weight change of the storage device is detected and the position of the weight change is determined. The weight change is then attributed to a storage unit corresponding to the position of the weight change.

### BACKGROUND

Oil field operations often entail the use of numerous solid materials, liquids or combinations thereof. The materials used are typically stored in storage units such as tanks and bins. Depending on the operations at hand, materials may be added to or removed from the storage units.

In order to ensure the availability of materials when needed and track material usage from the storage units, the contents of the storage units are typically monitored. Traditionally, the amount of materials in a storage unit is monitored by field personnel who may utilize level measurements to determine the amount of materials in a storage unit. However, the traditional methods for monitoring the amount of materials in a storage unit have several drawbacks.

First, the contents of the storage units cannot be constantly monitored. Moreover, the manual measurement of the amount of materials in a storage tank inherently gives rise to errors which may render the readings inaccurate. Finally, the materials contained in the storage units are often hazardous and pose a health risk to the field personnel attempting to conduct the measurements.

U.S. patent application Ser. No. 11/741,509, assigned to Halliburton Energy Services, Inc., discloses the use of load cells for monitoring the amount of materials in a storage unit. Oil field operations often involve the use of storage units with multiple bins where it may be desirable to monitor each bin individually. However, using a load cell system for each individual bin increases the amount of equipment necessary on the storage unit and may prove costly. Additionally, implementation on existing units would require significant redesign to isolate each bin for independent monitoring.

### FIGURES

Some specific example embodiments of the disclosure may be understood by referring, in part, to the following description and the accompanying drawings.

FIG. 1 is a top view of a multiple bin material storage device in accordance with an exemplary embodiment of the present invention.

FIG. 2 is a side view of the multiple bin material storage device of FIG. 1.

FIG. 3 is a free body diagram of the multiple bin material storage device of FIG. 1.

FIG. 4 is a free body diagram of a multiple bin material storage device in accordance with another exemplary embodiment of the present invention.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### SUMMARY

The present invention is directed to system and methods for monitoring multiple storage units. Specifically, the present invention is directed to system and methods for determining the amount of materials contained in individual storage units in a storage device with multiple storage units.

In one exemplary embodiment, the present invention is directed to a method of monitoring multiple storage units in a storage device comprising: detecting a weight change of the storage device; determining a position of the weight change; and attributing the weight change to a storage unit corresponding to the position of the weight change.

In another exemplary embodiment, the present invention is directed to a method of monitoring amount of materials in a plurality of bins in a multiple bin material storage device comprising: determining a first total weight of the multiple bin material storage device at a first point in time; determining a second total weight of the multiple bin material storage device at a second point in time; determining a weight change; wherein the weight change is the difference between the second total weight and the first total weight; determining a point on the multiple bin material storage device where the weight change occurred; identifying a bin corresponding to the point on the multiple bin material storage device where the weight change occurred; attributing the weight change to the bin

The features and advantages of the present disclosure will be readily apparent to those skilled in the art upon a reading of the description of exemplary embodiments, which follows.

### DESCRIPTION

The present invention is directed to system and methods for monitoring multiple storage units. Specifically, the present invention is directed to system and methods for determining the amount of materials contained in individual storage units in a storage device with multiple storage units.

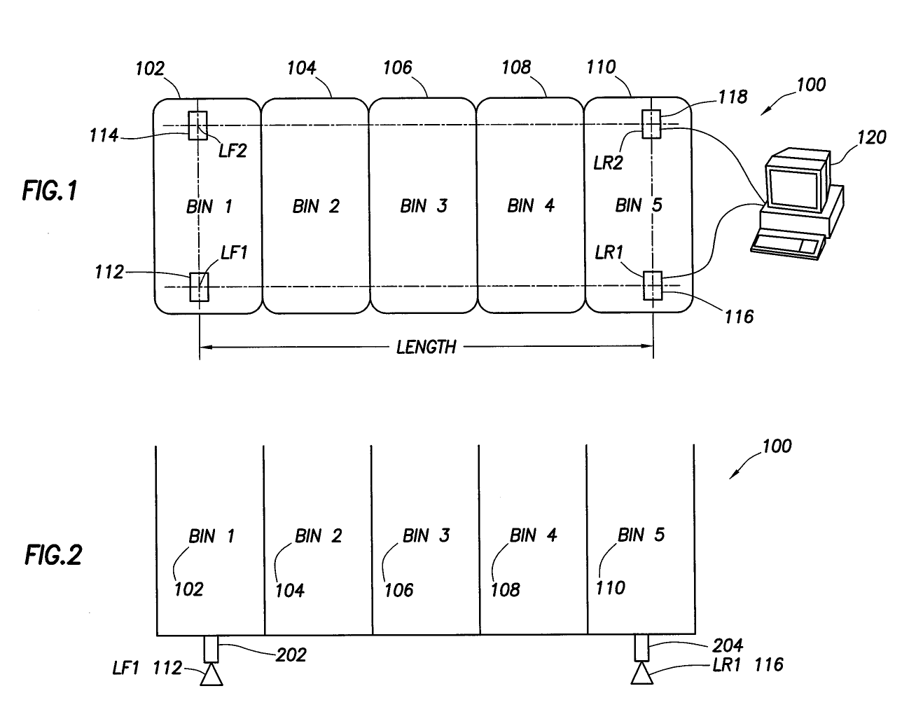

The details of the present invention will now be discussed with reference to the figures. Depicted in FIG. 1 is a top view of a Multiple Bin Material Storage Device (hereinafter, “MBMSD”) in accordance with an exemplary embodiment of the present invention denoted generally by reference numeral 100. The MBMSD 100 includes five individual bins denoted as Bin 1 102, Bin 2 104, Bin 3 106, Bin 4 108 and Bin 5 110. As would be appreciated by those of ordinary skill in the art, with the benefit of this disclosure, although the MBMSD 100 depicted in FIG. 1 has five bins, the present invention is not limited by the number of bins, and the number of bins used may be more or less than five depending on the user requirements. The MBMSD 100 has landing legs which support its total weight. In this exemplary embodiment, load sensors are attached to the MBMSD 100 to support the full force from the landing legs located at the opposing ends of the unit. Specifically, a first load sensor LF1 112 and a second load sensor LF2 114 are attached to the landing legs in the front of the MBMSD 100. Similarly, a first load sensor LR1 116 and a second load sensor LR2 118 are attached to the landing legs in the rear of the MBMSD 100.

In one exemplary embodiment, load cells are used as load sensors to determine the force exerted by gravity on the MBMSD 100. Electronic load cells are preferred for their accuracy and are well known in the art, but other types of force-measuring devices may be used. As will be apparent to one skilled in the art, however, any type of load-sensing device can be used in place of or in conjunction with a load cell. Examples of suitable load-measuring devices include weight-, mass-, pressure- or force-measuring devices such as hydraulic load cells, scales, load pins, dual sheer beam load cells, strain gauges and pressure transducers. Standard load cells are available in various ranges such as 0-5000 pounds, 0-10000 pounds, etc.

As would be appreciated by those of ordinary skill in the art, with the benefit of this disclosure, although the bins depicted in FIG. 1 are cubical, the bins may have any shape desired by the user, as long as the bins are not occupying the same vertical position on the unit. For instance, in another exemplary embodiment the bins may be cylindrical.

As would be appreciated by those of ordinary skill in the art, with the benefit of this disclosure, although the methods disclosed herein may be manually carried out by oil field personnel, in one exemplary embodiment, the load sensors LF1 112, LF2 114, LR1 116 and LR2 118 may be coupled to an information handling system 120 which may be used to process the information received from the load sensors as disclosed herein. Although FIG. 1 depicts a personal computer as the information handling system 120, as would be apparent to those of ordinary skill in the art, with the benefit of this disclosure, the information handling system 120 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the information handling system may be a network storage device, or any other suitable device and may vary in size, shape, performance, functionality, and price. The information handling system may use the methods disclosed herein to process the load sensor readings. Moreover, as would be appreciated by those of ordinary skill in the art, with the benefit of this disclosure, the load sensors LF1 112, LF2 114, LR1 116 and LR2 118 may be communicatively coupled to the information handling system 120 through a wired connection (as shown) or a wireless network (not shown).

Turning now to FIG. 2, a side view of the MBMSD 100 of FIG. 1 is depicted showing the storage bins Bin 1 102, Bin 2 104, Bin 3 106, Bin 4 108 and Bin 5 110. As depicted in FIG. 2, the MBMSD 100 rests on front landing legs 202 and rear landing legs 204 which are attached to load cells LF1 112, LF2 114 (not shown in FIG. 2), LR1 116 and LR2 118 (not shown in FIG. 2).

FIG. 3 depicts a free body diagram of the MBMSD 100 of FIG. 1. As depicted in FIG. 3, the total weight of the storage bins Bin 1 102, Bin 2 104, Bin 3 106, Bin 4 108 and Bin 5 110 is supported at the landing legs 202 and 204. Specifically, force A 302 is the reaction force at the landing legs 202 in the front of the MBMSD 100 and force B 304 is the reaction force at the landing legs 204 at the rear of the MBMSD 100. Moreover, as depicted in FIG. 3, the force on the front load sensors A 302, the force on the rear load sensors B 304 and the location of each of the storage bins Bin 1 102, Bin 2 104, Bin 3 106, Bin 4 108 and Bin 5 110, may be designated a one dimensional coordinate. In this exemplary embodiment, it is assumed that the zero coordinate is a vertical line through force A 302 and that force B 304 is applied at 40. Similarly, Bin 1 102 spans from −5 to 5, Bin 2 104 spans from 5 to 15, Bin 3 106 spans from 15 to 25, Bin 4 108 spans from 25 to 35 and Bin 5 110 spans from 35 to 45.

As would be appreciated by those of ordinary skill in the art, with the benefit of this disclosure, the reading at the front load sensors LF1 112 and LF2 114 and the rear load sensors LR1 116 and LR2 118 may be used to determine the forces A 302 and B 304, respectively, based on the following equation:

A=LF1+LF2

B=LR1+LR2

In accordance with an exemplary embodiment of the present invention, forces A 302 and B 304 are continually measured during the loading and unloading of the MBMSD 100. In one embodiment, the initial values of forces A 302 and B 304 before any of the storage bins Bin 1 102, Bin 2 104, Bin 3 106, Bin 4 108 and Bin 5 110 are loaded, is stored by the information handling system 120 as the tare weight of the empty unit. In one exemplary embodiment, the initial tare weight of the MBMSD 100 is zeroed out so that the tare is not included in the derivation calculations. In one embodiment, the information handling system 120 may include a data acquisition software to acquire readings from the load sensors LF1 112, LF2 114, LR1 116 and LR2 118 at a predetermined sampling frequency to determine if the total weight of the MBMSD 100 has changed.

In performing the methods disclosed herein, it is assumed that materials are only added and removed from a single bin at any given time. As would be appreciated by those of ordinary skill in the art, with the benefit of this disclosure, in one exemplary embodiment multiple bins may be combined and treated as a single bin when carrying out the methods disclosed herein. Accordingly, as material is added to or removed from any one of the storage bins Bin 1 102, Bin 2 104, Bin 3 106, Bin 4 108 and Bin 5 110, the change in weight (D) of the MBMSD 100 is determined using the following equation:

D=A2−A1+B2−B1

where A1 and B1 are the values of the forces A 302 and B 304, respectively, at a first point in time, t1, and A2 and B2 are the values of the forces A 302 and B 304, respectively, at a second point in time, t2. Once the system detects a change in the weight of the MBMSD 100, i.e., once D≠0, the position at which material was added or removed (P_{mat change}) from the system may be determined using the following equation:

P_{mat change}=L*(B2−B1)/D

where L is the horizontal distance between the front and the rear load cells. In the exemplary embodiment depicted in FIG. 3, L is the distance between the force A 302 at the front load sensors LF1 112 and LF2 114 and the force B 304 at the rear load sensors LR1 116 and LR2 118 which is 40. Accordingly, P_{mat change} is the distance from the origin where the change in weight (D) has occurred. In the example of FIG. 3, P_{mat change} is the distance between the location where the change in weight occurred and the point of application of the force A 302.

Once the value of P_{mat change} is determined using the above equation, the particular bin in which the change in weight occurred can be identified. Specifically, using the exemplary coordinates of the storage bins Bin 1 102, Bin 2 104, Bin 3 106, Bin 4 108 and Bin 5 110 of FIG. 3, the storage bin in which the change in material occurred may be determined using the following logic:
If −5≦P_{mat change}≦5, then D occurred in Bin 1 102;
If 5<P_{mat change}≦15, then D occurred in Bin 2 104;
If 15<P_{mat change}≦25, then D occurred in Bin 3 106;
If 25<P_{mat change}<35, then D occurred in Bin 4 108; and
If 35<P_{mat change}<45, then D occurred in Bin 5 110;

Accordingly, as material is added to or removed from one of the storage bins Bin 1 102, Bin 2 104, Bin 3 106, Bin 4 108 and Bin 5 110 of the MBMSD 100, each addition or removal may be associated with a particular storage bin.

In an exemplary embodiment, the information handling system 120 may receive the coordinates of the landing legs 202, 204 and storage bins Bin 1 102, Bin 2 104, Bin 3 106, Bin 4 108 and Bin 5 110 as an input from the user. The information handling system 120 may then monitor the readings of the load sensors LF1 112, LF2 114, LR1 116 and LR2 118 through a wired or wireless (not shown) network at a sampling interval which may be designated by the user. Once a weight change is detected, the information handling system 120 may initiate the calculations outlined above to identify the particular storage bin where the weight change occurred.

As would be appreciated by those of ordinary skill in the art, with the benefit of this disclosure, in one exemplary embodiment, the information handling system 120 may also receive information relating to the weight of each storage bin Bin 1 102, Bin 2 104, Bin 3 106, Bin 4 108 and Bin 5 110 as an input from a user. The information handling system 120 may then save that information in memory and use it to zero out the effect of the weight of the storage bins Bin 1 102, Bin 2 104, Bin 3 106, Bin 4 108 and Bin 5 110 in carrying out the above calculations.

In one embodiment, the information handling system 120 may maintain a virtual inventory of the storage bins of the MBMSD 100 as material is added or removed from each storage bin. Accordingly, a user may be able to monitor the contents of the storage bins at any given time. Moreover, in one exemplary embodiment, the user may designate a threshold weight and/or a threshold mass for the materials in one or more of the storage bins. In this embodiment, the information handling system 120 may alert the user when the amount of materials in the storage bin reaches the threshold value and the user may use that alert to add or remove materials from the storage bin. Finally, in one embodiment, the information handling system 120 may periodically save the bin totals, bin positions and offsets for the empty unit to long term memory for future access in the event of a system failure.

Although the MBMSD 100 disclosed herein is depicted as having landing legs at two locations, as would be appreciated by those of ordinary skill in the art, the same principles are applicable when the number of locations at which a MBMSD rests on the landing legs is different. Specifically, as would be appreciated by those of ordinary skill in the art, with the benefit of this disclosure, regardless of the number of landing legs or their positions, with the MBMSD stable, the sum of moments around any point on the MBMSD remains zero. Consequently, as would be appreciated by those of ordinary skill in the art, with minor modifications, the equations discussed above remain applicable to different numbers and arrangements of the landing legs.

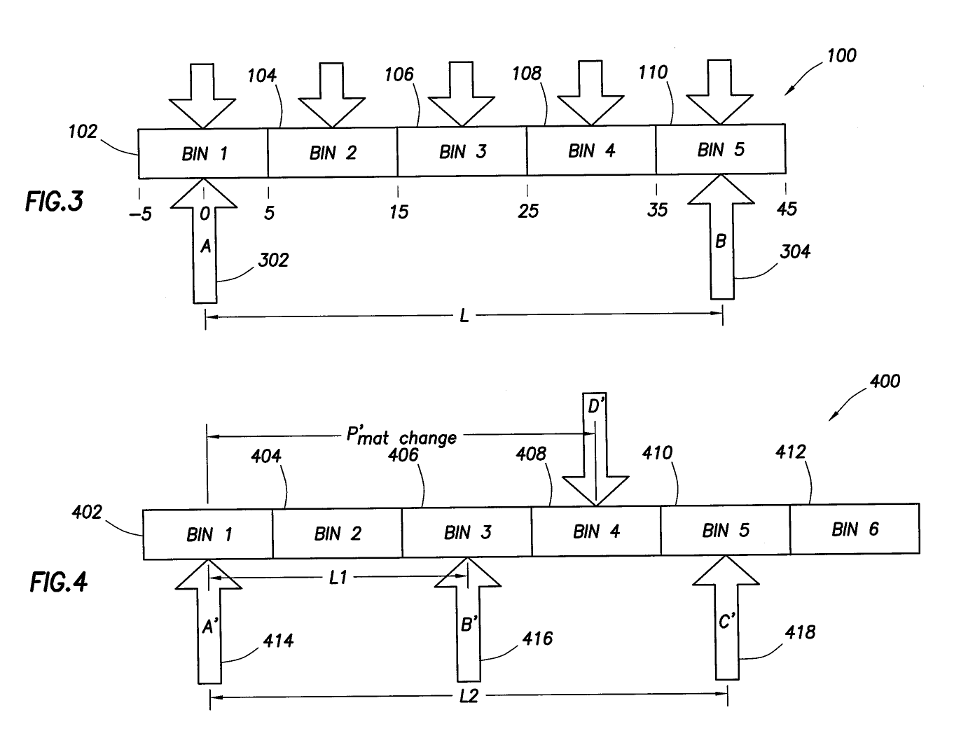

For instance, FIG. 4 depicts an MBMSD 400 resting on three landing legs. The MBMSD 400 may include six storage bins Bin 1 402, Bin 2 404, Bin 3 406, Bin 4 408, Bin 5 410 and Bin 6 412. Each landing leg is attached to one or more load sensors as discussed above and experiences a reaction force depicted as A′ 414, B′ 416 and C′ 418 respectively. The distance between forces A′ 414 and B′ 416 is denoted as L1 and the distance between forces A′ 414 and C′ 418 is denoted as L2. Assuming that forces A′1, B′1 and C′1 are the values of forces A′ 414, B′ 416 and C′ 418 respectively at a time t1 and forces A′2, B′2 and C′2 are the values of forces A′ 414, B′ 416 and C′ 418, respectively, at a time t2 where t2−t1 is the sampling interval, the change in weight (D′) of the MBMSD 400 as a result of an addition or removal of material from any one of the bins may be calculated as

D′=(A′2+B′2+C′2)−(A′1+B′1+C′1)

Because the MBMSD 400 remains stable, the total moment around any given point on the MBMSD 400 must remain zero. Applying this principle and designating force A′ 414 as the origin, the distance (P′_{mat change}) from force A′ 414 at which the change in weight D′ has occurred may be obtained using the following equation:

P′_{mat change}=((B′2−B′1)*L1)+((C′2−C′1)*L2)/D′

Once the value of P′_{mat change} is determined, a logic similar to that outlined above may be used to identify the storage bin corresponding to that position. The weight change may then be attributed to the identified storage bin. Accordingly, the principles disclosed herein are not limited to any specific number or configuration of landing legs on the storage device.

As would be appreciated by those of ordinary skill in the art, with the benefit of this disclosure, although the present invention is disclosed in the context of storage bins arranged in a single direction, similar implementations may be performed for units with multiple bins located in a two dimensional system. Moreover, as would be appreciated by those of ordinary skill in the art, with the benefit of this disclosure, additional functionality and accuracy may be added to the system with the addition of gate open sensors or manual input of bin masses or other information.

Although the present invention is disclosed in the context of storage bins, as would be appreciated by those of ordinary skill in the art, the same principle may be applied to other storage units such as tanks. Moreover, as would be appreciated by those of ordinary skill in the art, the storage units disclosed herein may contain a single solid material, a combination of solid materials, one or more fluids, slurries or any other useful material. Finally, although the present invention is disclosed in the context of oil field operations, as would be appreciated by those of ordinary skill in the art, with the benefit of this disclosure, the present invention may be utilized in any applications where it is desirable to monitor the amount of materials contained in multiple storage units.

Therefore, the present invention is well-adapted to carry out the objects and attain the ends and advantages mentioned as well as those which are inherent therein. While the invention has been depicted and described by reference to exemplary embodiments of the invention, such a reference does not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects. The terms in the claims have their plain, ordinary meaning unless otherwise explicitly and clearly defined by the patentee.

What is claimed is:

1. A method of monitoring multiple storage units in a storage device comprising:
detecting a weight change of the storage device;
determining a position of the weight change; and
attributing the weight change to a storage unit corresponding to the position of the weight change.

2. The method of claim 1, wherein detecting a weight change of the storage device comprises:
attaching landing legs of the storage device to one or more load sensors;
designating a sampling interval;
monitoring reaction forces on the one or more load sensors at the sampling interval; and
detecting a weight change when sum of reaction forces on the one or more load sensors changes in a sampling interval.

3. The method of claim 2, wherein the one or more load sensors are load cells.

4. The method of claim 2, wherein the one or more load sensors are communicatively coupled to an information handling system.

5. The method of claim 1, wherein determining the position of the weight change comprises determining the distance of point of the weight change from a point of origin.

6. The method of claim 1, wherein determining the position of the weight change comprises:
designating a landing leg of the storage device as a point of origin;
determining amount of change in reaction forces at each landing leg not designated as the point of origin;
multiplying the change in reaction forces at each landing leg not designated as the point of origin by the distance of that landing leg from the point of origin to obtain a change in moment for each landing leg not designated as the point of origin;
summing the change in moment of the landing legs not designated as the point of origin to obtain a sum of change in moments; and
dividing the sum of change in moments by the weight change of the storage device.

7. The method of claim 1, wherein one or more of the steps of detecting a weight change of the storage device; determining a position of the weight change; and attributing the weight change to a storage unit corresponding to the position of the weight change, is performed by an information handling system.

8. The method of claim 7, wherein the information handling system is a personal computer.

9. The method of claim 1, wherein the storage units are selected from the group consisting of a storage bin and a tank.

10. The method of claim 1, wherein attributing the weight change to a storage unit corresponding to the position of the weight change comprises:
determining a distance of each storage unit from a point of origin; and
comparing the position of the weight change with the distance of each storage unit from the point of origin to identify a storage unit where the weight change occurred.

11. A method of monitoring amount of materials in a plurality of bins in a multiple bin material storage device comprising:
determining a first total weight of the multiple bin material storage device at a first point in time;
determining a second total weight of the multiple bin material storage device at a second point in time;
determining a weight change;
wherein the weight change is the difference between the second total weight and the first total weight;
determining a point on the multiple bin material storage device where the weight change occurred;
identifying a bin corresponding to the point on the multiple bin material storage device where the weight change occurred; and
attributing the weight change to the bin.

12. The method of claim 11, further comprising maintaining a virtual inventory of amount of materials in each of the plurality of bins.

13. The method of claim 11, wherein determining the first total weight and the second total weight comprises:
attaching a load sensor to each leg of the multiple bin material storage device; and
summing the readings of the load sensors attached to each leg.

14. The method of claim 13, wherein the load sensor is a load cell.

15. The method of claim 13, wherein the load sensor is communicatively coupled to an information handling system.

16. The method of claim 11, wherein the weight change results from one of an addition of materials to a bin or a removal of materials from a bin.

17. The method of claim 11, wherein determining a point on the multiple bin material storage device where change in weight occurred comprises:
imposing a coordinate system on the multiple bin material storage device;
wherein a first leg of the multiple bin material storage device is at the origin of the coordinate system;
determining a coordinate for each remaining leg of the multiple bin material storage device;
wherein the coordinate for each remaining leg is a distance of each remaining leg of the multiple bin material storage device from the first leg of the multiple bin material storage device;
determining a change in reaction force at each remaining leg;
wherein the change in reaction force at each remaining leg is the difference in the reaction force at each remaining leg between the second point in time and the first point in time;
multiplying the change in reaction force at each remaining leg by the coordinate of each remaining leg; and
dividing a result of the multiplication by the weight change.

18. The method of claim 11, wherein one or more of the steps of determining the first total weight of the multiple bin material storage device at the first point in time; determining the second total weight of the multiple bin material storage device at the second point in time; determining the weight change; determining the point on the multiple bin material storage device where the weight change occurred; identifying the bin corresponding to the point on the multiple bin material storage device where the weight change occurred; and attributing the weight change to the bin, is performed by an information handling system.

19. The method of claim 18, wherein the information handling system is a personal computer.

20. The method of claim 11, wherein identifying a bin corresponding to the point on the multiple bin material storage device where the weight change occurred comprises:
imposing a coordinate system on the multiple bin material storage device;
wherein a first leg of the multiple bin material storage device is at the origin of the coordinate system;
designating a coordinate range to each bin;
determining a coordinate for the weight change; and
comparing the coordinate for the weight change with the coordinate range of each bin to determine in which bin the weight change occurred.
